(19) United States
(12) Patent Application Publication
(10) Pub. No.: US 2010/0073644 A1
(43) Pub. Date: Mar. 25, 2010

(54) SAFE LIGHT SCANNING PROJECTION DEVICE

(75) Inventor: Arnd Ritz, Heinsberg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/598,235

(22) PCT Filed: Apr. 30, 2008
(86) PCT No.: PCT/IB08/51676

§ 371 Date: Oct. 30, 2009

(30) Foreign Application Priority Data
May 3, 2007 (EP) 07107428.0

(51) Int. Cl. G03B 21/28; G02B 26/10; G03B 21/30

(52) U.S. Cl. 353/98; 359/205.1; 353/119

(57) ABSTRACT

The present invention relates to a projection device comprising a body (1) with a projection opening (2) for light projection. The body (1) encloses at least a light source (7), a scanning unit (8) and a deflection unit (3). The deflection unit (3) is mounted movable between an extended position and a non extended position. The scanning unit (8) is arranged and designed to scan a deflection area of the deflection unit (3) in the extended position with a light beam emitted by the light source (7). In the extended position part of the deflection unit (3) extends through the projection opening (2) to prevent a human eye to come too close to the projection opening (2). In the extended position the deflection unit (3) deflects the light beam from the scanning unit (8) towards a projection area. In the non extended position the deflection unit (3) does not deflect the light beam from the scanning unit (8) through the projection opening (2). With the proposed projection device the human eye is protected to come too close to the projection opening (2) during normal operation of the projection device.

### FIELD OF THE INVENTION

The present invention relates to a projection device comprising a body with a projection opening for light projection, said body enclosing at least a light source and a scanning unit for scanning a projection area with a light beam emitted by the light source. The invention especially relates to a projection device for handheld projection.

### BACKGROUND OF THE INVENTION

Laser sources have recently attracted a lot of interest for handheld projection devices. Small sized scanning beamer units of only a few cm³ of volume, but still capable of delivering a usable picture of about an A4-size, are expected to find a broad application as stand-alone applications like pico-beamers but also as integrated projectors in smart phones or personal digital assistants (PDA).

For projection of the described kind laser power of about 70 mW cw is necessary. Laser radiation with such a power, spread by a scanning unit into a cone to illuminate the desired projection area, is able to damage the human eye when exposed to the diverging laser beam at a distance too close to the projection device. Due to the dilution of the radiation with increasing distance from the projection device, the level of hazard decreases with increasing distance. Dependent on the design parameters of the scanning unit the hazard distance for such a projection device can be limited to within a few centimeters from the projection opening of the projection device. A person bringing its eye within this hazard distance into the cone of the projection light could suffer eye damages. This exposure might happen especially to children playing around with such devices, which often are designed for fun and gaming applications.

The application of fixed tubes or spacers around the projection light cone would spoil the design of the application. Transportability would be deteriorated and in case of integrated projection devices the use of other features would be hindered. Furthermore such tubes or spacers could be taken off or destroyed intentionally or accidentally making accessible the hazard region for the human eye.

US 2005/0242185 A1 discloses a projection device which prevents the eye from damage if the scanning unit of this device malfunctions or stops. For achieving this safety function a light modulator is arranged between the laser light source and the scanning unit. The light modulator redirects the light in case of a scanner malfunction away from the scanning unit and is controlled by a feedback system monitoring the operation of the scanning unit. The projection device of this document electronically prevents the emission of the scanning light beam if the scanning unit fails, but does not prevent damage to the eye if a person comes too close to the projection opening with its eye.

### SUMMARY OF THE INVENTION

It is an object of the present invention to provide a projection device, in particular for handheld applications, which comprises a safety mechanism preventing damage to the eye during normal operation of the device.

The object is achieved with the projection device according to claim 1. Advantageous embodiments of the projection device are subject matter of the dependent claims or are described in the subsequent portion of the description.

The proposed projection device comprises a body with a projection opening for light projection, said body enclosing at least a light source, a scanning unit and a deflection unit. The deflection unit is arranged movable between an extended position and a non extended position. The term “position” in this context means the place and/or the orientation or alignment of the deflection unit. The scanning unit is arranged and designed to scan a deflection area of the deflection unit with a light beam emitted by the light source when the deflection unit is in the extended position. The deflection area is the portion of the deflection unit which is scanned by the scanning unit to deflect the light from the scanning unit. In this extended position part of the deflection unit extends through the projection opening to the outside of the body to prevent a human eye to come too close to the projection opening for causing damage to the eye by the sweeping light beam. In this extended position the deflection unit deflects the light beam from the scanning unit towards the projection area. In the non extended position the deflection unit is arranged and/or aligned such that it does not deflect the light beam from the scanning unit through the projection opening.

With the proposed projection device a mechanical screening of the hazard zone close to the projection opening of the projection device is provided, that is indispensable for the function of the projection device, i.e. for light projection towards a projection area. This mechanical screening is achieved by a deflection unit which, when in place or alignment for deflection (extended position) prevents the user to access hazardous levels of radiation. When the deflection unit is not in its extended position (non extended position) the light from the scanning unit is not deflected through the projection opening. Depending on the construction of the deflection unit and the mechanics to move this deflection unit, the deflection unit may deflect the light from the scanning unit towards the inside of the body in the non extended position or may be outside of the scanning path of this scanning unit. In both cases, the light beam coming from the scanning unit is not deflected to the outside of the body so that no hazardous radiation can reach the eye. Only in the extended position the light beam from the scanning unit is deflected with a hazardous power level towards the projection area. In this position the extended portion of this deflection unit avoids that any person may come too close to the projection opening for causing damage to the eye. When the deflection unit is taken away intentionally, the light from the scanner unit is not or only partly deflected through the projection opening. This light is then partitioned and scattered such inside of the body that no or only non critical amounts of light can be accessed. A further advantage of the proposed projection device with such a preferably user operated mechanical screening is that the user cannot start the projector unintentionally and also persons around have the opportunity to get prepared to the emission of the light radiation. This also helps to increase the safety of the application. Since the scanning light beam is only fully deflected to the outside in the extended position of the deflection unit, no or only a uncritical portion of light is deflected to the outside in any intermediate position of the deflection unit, e.g. when the deflection unit is moved between is extended and non extended position.

The light source of the proposed projection device is preferably a laser light source. Nevertheless also other light sources with the required high intensity level for the desired light projection may be used if appropriate. The scanning unit may be a mirror tiltable in one or two directions depending on the application. Furthermore, also two consecutive mirrors for two different scanning directions can be used as known in the art. Generally any kind of scanning unit, for example also a micro mirror device or an acousto-optic modulator, may be used. The deflection unit is preferably formed of a mirror plate. Nevertheless, also any other types of deflection devices like for example prisms can be used.

In a preferred embodiment the deflection unit is mounted rotatably in order to allow a rotation of the deflection unit between the extended position and the non extended position about a rotation axis. Preferably this deflection device closes the projection opening when in its non extended position. The rotation axis for the rotating movement of the deflection unit is aligned parallel to the deflecting surface of the deflection unit. The body may comprise appropriate holding means to hold the deflection unit removable in the extended position and in the non extended position. This may be achieved for example by snap in mechanisms or by appropriate spring forces.

The same applies to other embodiments of the projection device using other types of movement between the extended position and the non extended position. The deflection unit is moved between the extended and non extended positions preferably manually by the user. Nevertheless it is also possible to provide a motorized movement of the deflection unit, for example coupled to an on/off switch of the projection device.

The projection device of the present invention preferably is designed as a handheld device, i.e. the complete volume of the body enclosing the light source, the scanning unit and the deflection unit has a volume of only few cm³, in particular of less than 20 cm³, preferably of less than 10 cm³. The deflection unit then, depending on the power of the light source, extends in the extended position to a distance of between 1 and 7 cm, preferably to a distance of between 3 and 5 cm, through the projection opening. Such a deflection device may be designed as a stand-alone-application like a pico-beamer. It may also be integrated in common handheld devices like, for example, smart phones or PDA's.

In a further preferred embodiment the deflection area is arranged such on the deflection unit that it extents to the outside of the housing. This requires an appropriate arrangement of the scanning unit with respect to the deflection unit. In such an embodiment a destruction of only the extended portion of the deflection unit would cause only part of the scanning light to be still projected in the direction of the projection area and another part of the scanning light to leave the projection opening under a small angle. This lowers the light power in the direction of the projection area on the one hand whereas on the other hand the light power leaving the projection opening at the small angle is also only a fraction of the light power emitted by the light source. Therefore, even in such a case of partial destruction of the deflection unit the risk of damage to the eye approaching too close to the projection opening is reduced.

These and other aspects of the invention will be apparent from and elucidated with reference to the embodiments described herein after.

### BRIEF DESCRIPTION OF THE DRAWINGS

The proposed projection device is described in the following by way of examples in connection with the accompanying figures without limiting the scope of protection as defined by the claims. The figures show:

FIG. 1 a schematic view of an example of the proposed projection device with the deflection unit in the non extended position;

FIG. 2 a schematic view of the projection device of FIG. 1 with the deflection unit in the extended position;

FIG. 3 a schematic side view of the projection device of FIG. 1 with the deflection unit in the extended position;

FIG. 4 a schematic side view of a further example of the proposed projection device with the deflection unit in the non extended position; and

FIG. 5 a schematic side view of the projection device of FIG. 4 with the deflection unit in the extended position.

### DETAILED DESCRIPTION OF EMBODIMENTS

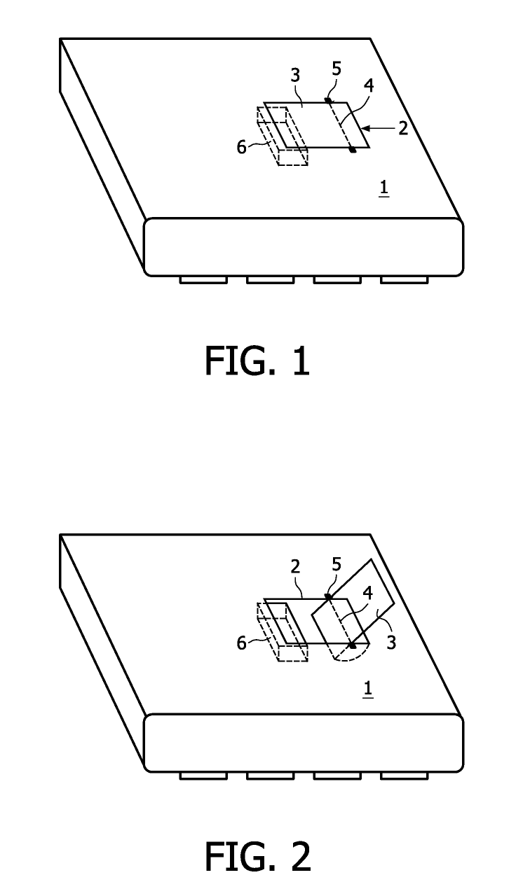

FIG. 1 shows a schematic view of one embodiment of the proposed projection device from the outside. In this example the projection device is part of a smart phone, the backside of which is visible in this figure. The body 1 therefore not only contains the components of the projection device but also further components necessary for operation of the smart phone. The further components are not depicted in the figures since these components are not necessary for the operation of the proposed projection device.

In the example of FIG. 1 a laser light source and a scanning unit are part of a scanning module 6 which is schematically shown inside of the body 1. The projection opening 2 of body 1 in FIG. 1 is closed by a rotatable mirror plate 3 shown in a non extended position. This rotatable mirror plate 3 is the deflection unit of the proposed projection device. FIG. 1 shows the off state of the projection device when the projector is not in use. In this state either no light is emitted by the scanning module 6 or light emitted by the scanning module remains inside of the body 1 and can not cause damage to the human eye.

The mirror plate 3 is mounted in the projection opening 2 to be rotatable around a rotation axis 4. To this end, the mirror plate 3 is suspended in the body 1 in appropriate bearings 5. When rotating the mirror plate 3 to its extended position shown in FIG. 2, a larger part of the mirror plate 3 extends through the projection opening 2 to the outside and a smaller part remains inside of the body 1. In this extended position the light emitted by scanning module 6 is deflected by the mirror plate 3 towards a desired projection area. In this position the mirror plate 3 sticks out of the body and prevents the user from bringing his eye in too close to the projection opening 2.

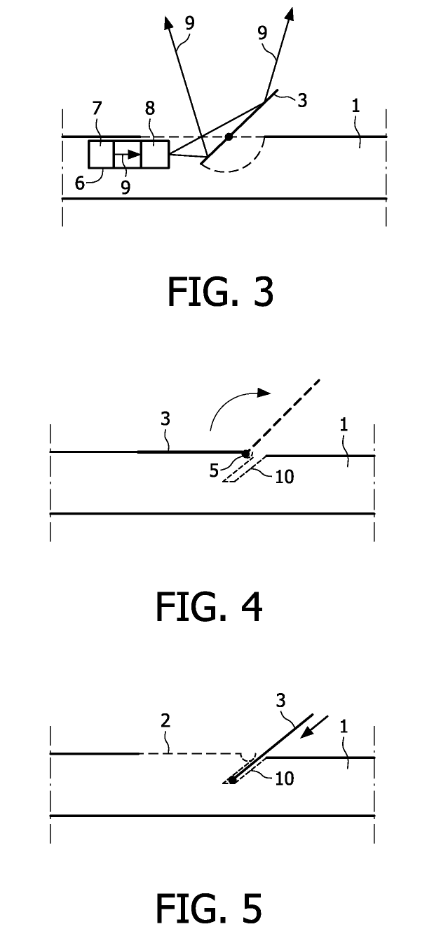

The light deflection of the mirror plate 1 in its extended position can clearly be seen in the side view of FIG. 3. In this side view the laser light source 7 and the scanning unit 8 as parts of the scanning module 6 are schematically indicated. Light beam 9 emitted by the laser light source 7 is swept by the scanning unit 8 to a deflection area of the mirror plate 3 which also might be mounted on a carrier. The scanning unit 8 is arranged such that the deflection area extends to the outside of the body 1 as can be seen in FIG. 3. The deflected light beam 9 is then projected onto an appropriate projection area (not shown in the figures).

As can clearly be recognized from FIG. 3, the light from scanning unit 8 is directed to the deflection area of the mirror plate 3 which is positioned partly within the body 1. The mirror plate 3 reflects the light cone from the scanning unit 8 with the image information out of the body into the direction of the projection area, for example an appropriate screen. The part of the mirror plate 3 sticking out of the body prevents the user from bringing its eye to close the projection opening 2. If the mirror plate 3 is completely broken away, a large amount of the light is directed into the body 1 and either absorbed or distributed by reflection and scattering into a large solid angle, such that a human eye can only collect non hazardous amounts of radiation. The light escaping from the body directly from the scanning unit leaves the body under a small angle to the surface. This light can fall into an eye only behind the body, i.e. outside of the hazardous region, which for this fraction of the nominal output is even smaller. If the mirror plate 3 is partly broken away, then there are two components of reduced laser power. One component is directed to the projection area by the remaining part of the mirror plate 3 and one component is leaving nearly parallel to the surface of the body. As both components are of lower power, none of them can cause a hazardous situation.

In the off state of the projection device, when the projector is not in use, the mirror plate 3 can be swept and close the projection opening 2 as shown in FIG. 1. In this way the projection unit is protected.

With such a construction of the projection device, also use and handling of other features of the application into which this projection device is integrated, for example a phone or a camera, can be used without interference of the mechanical screening function of the projector. The projection device may also comprise additional means, for example a switch which detects whether the mirror plate 3 is there and is correctly placed.

FIG. 4 shows a further example in which the mirror sweep axis, i.e. the rotation axis 4, is positioned at the end of the mirror plate 3. In this case, the mirror plate 3 has to be tilted first to the deflecting orientation, as indicated in the schematic side view of FIG. 4, and then shifted into a slit 10 to reach its extended position for deflecting the light of the scanning unit outside of the projection opening 2, as indicated in FIG. 5. The slit 10 is designed to maintain the deflecting orientation of the mirror plate 3. With this construction no extra space for the sweeping of the mirror plate 3 inside of the body has to be consumed.

While the invention has been illustrated and described in detail in the drawings and forgoing description, such illustration and description are to be considered illustrative or exemplary and not restrictive, the invention is not limited to the disclosed embodiments. The different embodiments described above and in the claims can also be combined. Other variations to the disclosed embodiments can be understood and effected by those skilled in the art in practicing the claimed invention, from a study of the drawings, the disclosure and the appended claims. For example, the deflection unit may also be formed of a prism like reflector or the projection opening may have another than the rectangular shape shown in the figures. Furthermore the mirror plate, e.g. in the example of FIGS. 4 and 5, may be provided without any rotation axis. The mirror plate may only be clipped to its deflecting/extended position for operation and removed when it is not used, i.e. when the device is not operated. This only requires a clamp or mounting to fix the mirror plate in its extended position and from which the mirror plate can be manually removed.

In the claims, the word “comprising” does not exclude other elements or steps, and the indefinite article “a” or “an” does not exclude a plurality. The mere fact that measures are recited in mutually different dependent claims does not indicate that a combination of these measures can not be used to advantage. Any reference signs in the claims should not be construed as limiting the scope of these claims.

### LIST OF REFERENCE SIGNS

1 body
2 projection opening
3 mirror plate
4 rotation axis
5 bearings
6 scanning module
7 laser light source
8 scanning unit
9 light beam
10 slit

1. A projection device comprising:
a body with a projection opening for light projection, and, disposed at least partially within said body:
a light source,
a deflection unit having a deflection area and movable between an extended position and a non-extended position, and
a scanning unit being arranged and configured to scan the deflection area in the extended position with a light beam emitted by the light source,
wherein, in the extended position, a first part of the deflection unit extends through the projection opening, a second part of the deflection unit remains within said body and the deflection unit deflects the light beam from the scanning unit towards a projection area,
wherein at least a portion of the defection area is located on the second part of the deflection unit, and
wherein, in the non-extended position, the deflection unit does not deflect the light beam from the scanning unit through the projection opening.

2. The projection device according to claim 1, wherein the deflection unit is mounted at the projection opening to be at least partly rotatable around a rotation axis parallel to the deflection area.

3. The projection device according to claim 2, wherein the deflection unit is rotatable around said rotation axis between the extended position and the non-extended position, closing the projection opening in the non-extended position.

4. The laser scanning projection device according to claim 1, wherein the deflection unit is a mirror plate.

5. The laser scanning projection device according to claim 1, wherein the deflection unit is a mirror plate and the body comprises bearings and a slit for the mirror plate, the bearings allowing a rotation of the mirror plate between the non-extended position and a deflecting orientation for deflecting the light beam towards the projection area and a subsequent movement of the mirror plate maintaining the deflecting orientation into the slit of the body to the extended position, the slit being aligned to maintain the deflecting orientation or the mirror plate.

6. The laser scanning projection device according to claim 1, wherein the light source, the scanning unit and the deflection unit are disposed within the body in a volume of ≦20 cm³.

7. The laser scanning projection device according to claim 6, wherein the deflection unit extends through the projection opening in the extended position to a distance of between 1 cm and 7 cm.

8. The laser scanning projection device according to claim 7, wherein the light source (7) is a laser light source emitting laser radiation with a laser power of ≦250 mW cw.

9. The projection device according to claim 1, wherein the scanning unit (8) is aligned such that part of the deflection area of the deflection unit is situated outside of the body.

10. (canceled)
